(19) United States
(12) Patent Application Publication
(10) Pub. No.: US 2007/0238404 A1
(43) Pub. Date: Oct. 11, 2007

(54) APPARATUS AND METHOD FOR VACUUMING PARTICLES OR FUMES FROM FINGER NAIL TREATMENTS

(75) Inventors: Seong Han Park, East Rutherford, NJ (US); Yong Sub Oh, Palisades Park, NJ (US); Chang Gyu Jang, Bayside, NY (US)

Correspondence Address: WALTER J, TENCZA JR., 10 STATION PLACE, SUITE 3, METUCHEN, NJ, 08840, US

(73) Assignee: BAU INTERNATIONAL, INC., Hackensack, NJ (US)

(21) Appl. No.: 11/308,603

(22) Filed: Apr. 11, 2006

(51) Int. Cl. B08B 15/02; B01D 50/00; A45D 29/18

(52) U.S. Cl. 454/56; 55/385.2; 132/73.5

(57) ABSTRACT

An apparatus is provided including an air diffuser, a filter, a cover, a fan, and a shade in which the fan is located. The air diffuser may be surrounded by the filter except for a bottom opening in the air diffuser. The cover may surround the filter and the air diffuser except for a bottom opening in the filter and the bottom opening in the air diffuser. The air diffuser and the cover may be attached to the shade. The shade may have a bottom opening. The fan may cause air to flow into the shade through the bottom opening of the shade, then through the bottom opening of the air diffuser, the filter, and a first opening of the cover, then out a set of a plurality of openings in a side of the air diffuser, then through the filter, and then out a set of a plurality of openings in the cover.

### FIELD OF THE INVENTION

This invention relates to improved methods and apparatus concerning removal of fingernail particles, noxious fumes, or particles resulting from finger nail treatments.

### BACKGROUND OF THE INVENTION

There are various devices known in the prior art for drawing in and dispersing harmful fumes or particles. For example, U.S. Pat. No. 3,510,228 to May provides a work lamp having a light source annular in shape and an exhaust fan to draw gasses through the center of the annulus. (May, col. 1, In. 68-col. 2, In. 1). U.S. Pat. No. 4,868,369 to Chen provides an articulated support 18, a hood 13, a fan 15, an activated charcoal filter 14, and an annularly shaped fluorescent lamp grille or screen 133. (Chen, col. 3., In. 45-col. 4, In. 55). The fan 15 sucks in noxious gasses from a soldering operation for filtration by the filter 14 and eventually feeds the gasses into an outlet port 172. (Id.) U.S. Pat. No. 4,109,144 to Widmar discloses drawing in a stream of air and dust particles, from around a workpiece 30 through a reflector 38 and flexible conduit 42 to a manifold 20. (Widmar, col. 3, Ins. 14-35). The stream of air flows around a light bulb 48. (Id.)

U.S. Pat. No. 4,280,519 to Chapman relates to the field of manicuring facilities (Chapman, col. 1, Ins. 5-10) and provides an exhaust means 16 for removal of dust and nauseous fumes and odors from a manicuring environment. (Chapman, col. 2, Ins. 13-27). The exhaust means 16 in Chapman is embedded in a tabletop 20. (Id.) U.S. Pat. No. 5,125,939 to Karisson provides a suction hood 10 for drawing gasses away from a work place area. (Karisson, col. 2, Ins. 1-17). U.S. Pat. No. 5,336,128 to Birdsong relates to a device for removing fumes and vapors from the work area of a nail technician. (Birdsong, col. 1, Ins. 5-8). Birdsong provides a hood 12 having openings 70, 72, 74, and 76 for placing hands of a customer and a nail technician. (Birdsong, col. 5, Ins. 15-33). Two outlet ports 50 and 52 are provided for drawing fumes and vapors from a chamber 30 of the hood 12. (Birdsong col. 5, Ins. 34-39).

U.S. Pat. No. 5,464,029 to Rentz provides an environmental chamber 23 which is loosely sealed by curtains 37 and 38 through which hands of a manicurist and customer can be inserted. (Rentz, col. 4, Ins. 58-67). Fumes are evacuated by an exhaust motor and fan 39 placed near a side wall of the environmental chamber. (Rentz, FIG. 2, col. 4, Ins. 58-67). U.S. Pat. No. 6,308,707 to Lu provides a vacuum device 30 including a fan 32, and a filter 35 for inhaling in dirty air breathed out by a hospital patient or mist spit out from a patient's mouth. (Rentz, col. 1, In. 35-43).

### SUMMARY OF THE INVENTION

One or more embodiments of the present invention provide an apparatus comprising an air diffuser, a filter, a cover, a fan, and a shade or hood in which the fan is located. The air diffuser may be surrounded by the filter except for a bottom opening in the air diffuser at a bottom of the air diffuser. The cover may surround the filter and the air diffuser except for an opening in the filter at a bottom of the filter and the bottom opening in the air diffuser. The air diffuser and the cover may be attached to the shade. The shade may have an opening at the bottom of the shade. The fan may cause air to flow into the shade through the opening of the shade, then through the bottom opening of the air diffuser, the filter, and a first opening of the cover, then out a set of a plurality of openings in a side of the air diffuser, then through the filter, and then out a set of a plurality of openings in the cover.

The set of the plurality of openings in the cover may be substantially uniformly spaced. The air diffuser may be substantially frustroconical in shape and may have a central axis. The cover may be substantially frustroconical in shape and may have a central axis. The air diffuser and the cover may be attached to the shade or hood so that the central axis of the air diffuser and the central axis of the cover substantially overlap. The air diffuser and the cover may each be substantially symmetrical about its own central axis. The set of the plurality of openings in the side of the air diffuser may be uniformly spaced. The shade or hood may have a light located therein. The light may be focused in the opposite direction of the air flow into the shade.

One embodiment of the present invention provides a method including vacuuming fingernail particles, noxious particles, and fumes by using an apparatus as previously described. A fingernail treatment process may create the fingernail particles, noxious particles, and fumes.

### BRIEF DESCRIPTION OF THE DRAWINGS

FIG. 1 shows a perspective view of an air diffuser, a filter, and a cover in accordance with an embodiment of the present invention;

FIG. 2 shows a perspective view of the cover attached to a shade and lampholder, with the air diffuser, and filter inside of the cover, in accordance with an embodiment of the present invention;

FIG. 3 shows a perspective view of the apparatus of FIG. 2 attached to a top connector, flexible metal stand, bottom connector, and table holder in accordance with an embodiment of the present invention;

FIG. 4A shows a side view of the air diffuser of FIG. 1;

FIG. 4B shows a bottom view of the air diffuser of FIG. 1;

FIG. 4C shows a top view of the air diffuser of FIG. 1;

FIG. 5A shows a side view of the cover of FIG. 1;

FIG. 5B shows a bottom view of the cover of FIG. 1;

FIG. 5C shows a top view of the cover of FIG. 1;

FIG. 6A shows a side view of the shade and lampholder of FIG. 2;

FIG. 6B shows a bottom view of the shade and lampholder of FIG. 2;

FIG. 6C shows a top view of the shade and lampholder of FIG. 2;

FIG. 7 shows a front view of the cover, filter, and air diffuser of FIG. 1 and the shade or hood of FIG. 2;

FIG. 8A shows a front view of the air diffuser connected to the shade and the filter placed over the air diffuser, with the filter shown in dashed lines, and the cover unattached from the shade;

FIG. 8B shows a front view of the cover attached to the shade;

FIG. 9A shows a side view of an air diffuser in accordance with another embodiment of the present invention;

FIG. 9B shows a bottom view of the air diffuser of FIG. 9A; and

FIG. 9C shows a top view of the air diffuser of FIG. 9A.

### DETAILED DESCRIPTION OF THE DRAWINGS

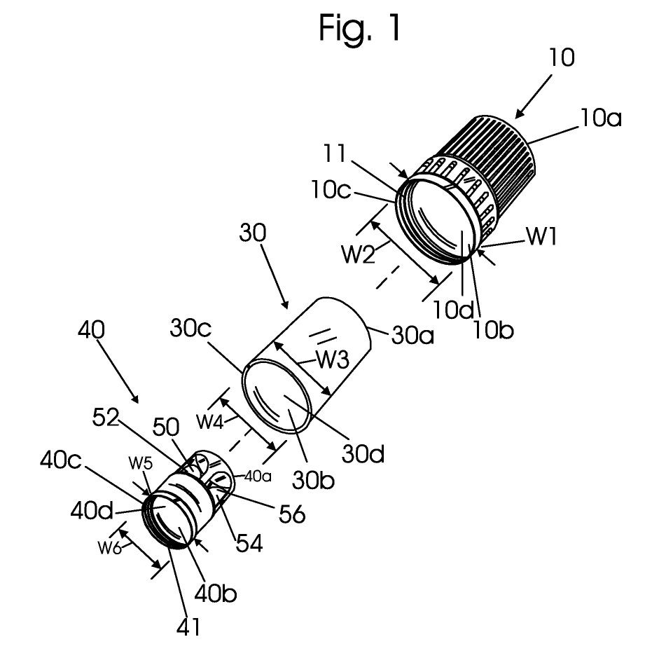

FIG. 1 shows a perspective view of an air diffuser 40, a filter 30, and a cover 10 in accordance with an embodiment of the present invention.

The filter 30 may be a substantially cylindrical bag with an opening 30b at an end 30c leading into a chamber 30d, and a closed end 30a. The filter 30 may be an activated carbon fiber filter. The filter 30 may have an inner width W4, at the end 30c, which may be about six inches and an outer with W3, near the end 30c, which may be about six and ½ inches.

The air diffuser 40 may have an outer width of W5, at and end 40c, which may be about four and ¼ inches, which is less than the inner width W4 of the filter 30. The air diffuser 40 may have an opening 40b at the end 40c leading to a chamber 40d, and a closed end 40a. The air diffuser 40 may have an inner width of W6 at the end 40c. The air diffuser 40 can be inserted into the filter 30 by inserting end 40a of the air diffuser 40 into the opening 30b of the filter 30, such that the filter 30 covers the air diffuser 40.

The cover 10 may be have a substantially cylindrical shape with exceptions as will be described. The cover 10 may have an outer width of W1, which may be six and ¾ inches, and an inner width of W2, which may be six and ⅝ inches, at an end 10c. The cover 10 may have an opening 10b at end 10c, leading to a chamber 10d within the cover 10. The cover 10 may an end 10a. The combination of the air diffuser inserted into the filter 30, can be inserted into the cover 10 by inserting end 30a of the filter 30 (with the filter 30 covering the air diffuser 40) into the opening 10b and into the chamber 10d of the cover 10.

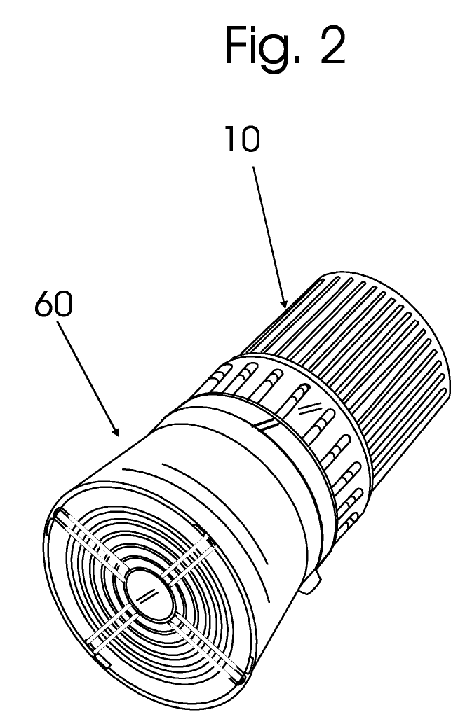

FIG. 2 shows a perspective view of the cover 10 attached to a shade and lampholder 60, with the air diffuser 40, and filter 30 inside of the cover 10, in accordance with an embodiment of the present invention. The shade and lampholder 60 may have a frustroconical shape. As shown in FIG. 1, the cover 10 includes ridges or threads 11 on the inner surface of section 12 of the cover 10. The ridges or threads 11 can be used to secure the cover 10 (an air diffuser 40 and filter 30 which are inside the cover 10) to the shade and lampholder 60, as shown in FIG. 2.

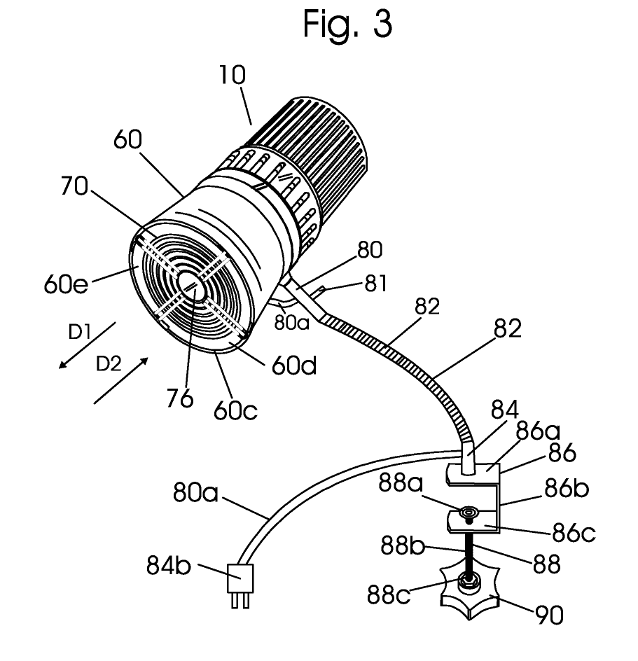

FIG. 3 shows a perspective view of the apparatus of FIG. 2 attached to a top connector 80, flexible metal stand device 82, bottom connector 84, and table holder 86 in accordance with an embodiment of the present invention. FIG. 3 represents a completed apparatus 1 in accordance with an embodiment of the present invention. The flexible metal stand device 82 can be used to adjust the combination of the shade and lampholder 60, cover 10, air diffuser 40, and filter 30.

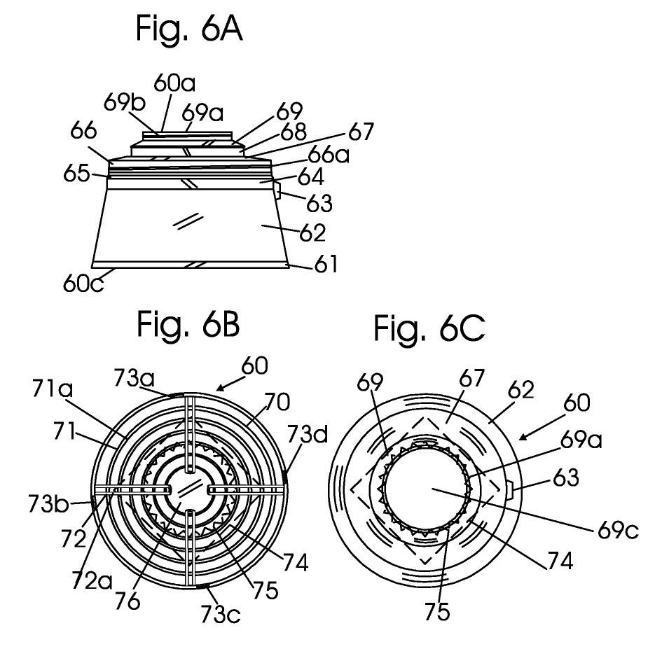

An electrical conductor or cord 80a may run from the top connector 80 to the shade and lampholder 60 for supplying electricity to a fan 75 and a lamp 76, shown in simplified form in FIG. 6B and located within the shade and lampholder 60. The electrical cord 80a may run through the flexible metal stand device 82 and the bottom connector 84. The electrical cord 80a may exit the bottom connector 84 and may be connected to a plug 84b for plugging into an electrical outlet for supplying power to the fan 75 and the lamp 76.

The table holder 86 may include a vise which may be comprised of a top plate 86a, a connecting plate 86b, a bottom plate 86c, a clamping bolt 88, and a handle 90. The clamping bolt may include an end piece 88a, a threaded piece 88b, and a bolt 88c. The bolt 88c attaches the clamping bolt 88 to the handle 90.

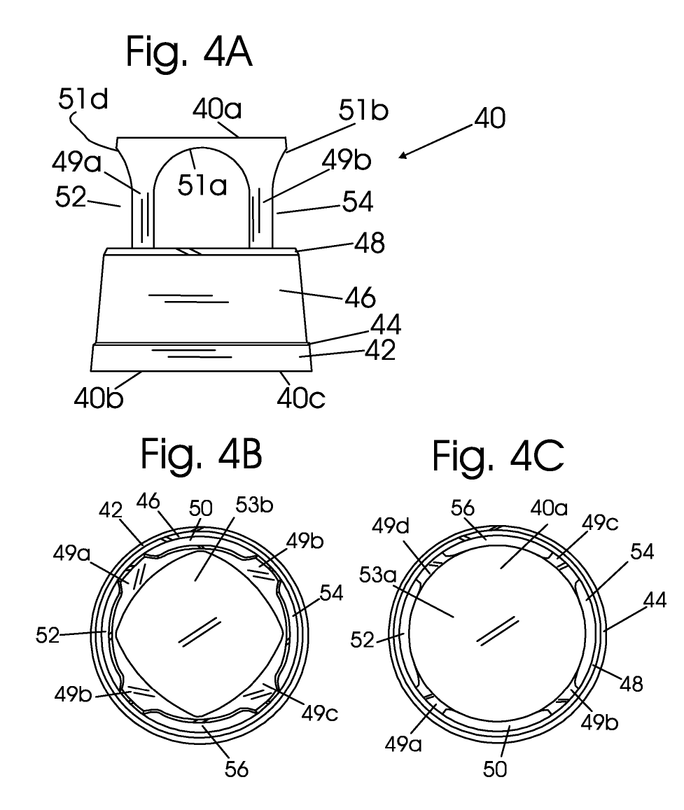

FIGS. 4A-C show side, bottom, and top views of the air diffuser 40 of FIG. 1. The air diffuser 40 includes sections 42, 44, 46, 48, 49a, 49b, 49c, and 49d. Each of sections 42, 44, 46, and 48 are substantially cylindrical with a decreasing outer and inner diameter from an end 40c towards end 40a. This may allow plastic to be molded more easily. The air diffuser 40 also includes openings 50, 52, 54, and 56. The openings 50, 52, 54, and 56 may be the same size spaced uniformly around the perimeter of the air diffuser 40. The openings 50, 52, 54, and 56 have a substantially rectangular portion near section 48 and a semicircular portion near end 40a. The air diffuser 40 includes a top surface 53a shown in FIG. 4C and an inner surface 53b shown in FIG. 4B. Each of the openings 50, 52, 54, and 56 may have a width of W7, which may be about one and seven eighths inches, and a height HI, which may be about one and seven eighths inches.

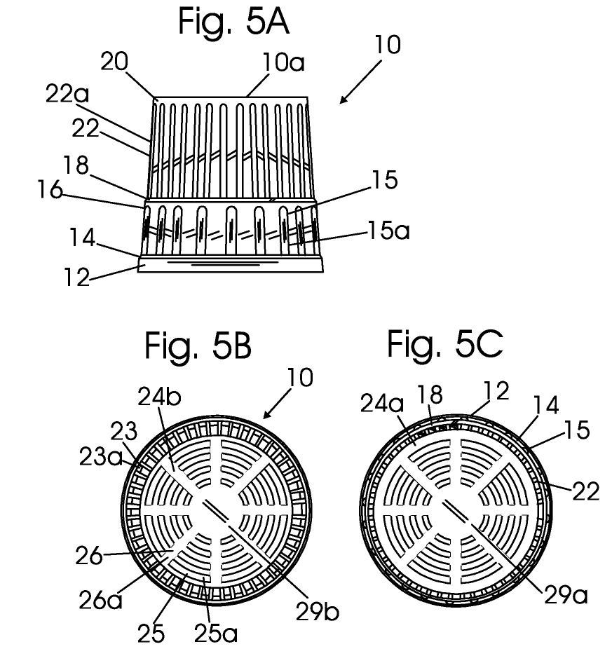

FIGS. 5A-C show side, bottom, and top views of the cover 10 of FIG. 1. The cover 10 includes sections 12, 14, 16, 18, and 20. Each of sections 12, 14, 16, 18, and 20 are substantially cylindrical with a decreasing outer and inner diameter from the end 10c to the end 10a. The cover 10 also includes a plurality 15 of substantially uniformly spaced ridges which include ridge 15a on section 16. The cover 10 also includes a plurality of substantially uniformly spaced elongated openings 22, which includes opening 22a. The cover 10 includes an inner surface 24b and an outer surface 24a shown by FIGS. 5B and 5C. The surfaces 24a and 24b have a plurality of peripherally spaced openings 25 which are separated by sections 26, such as 26a. The cover 10 has a central top surface 29a and a central bottom surface 29b.

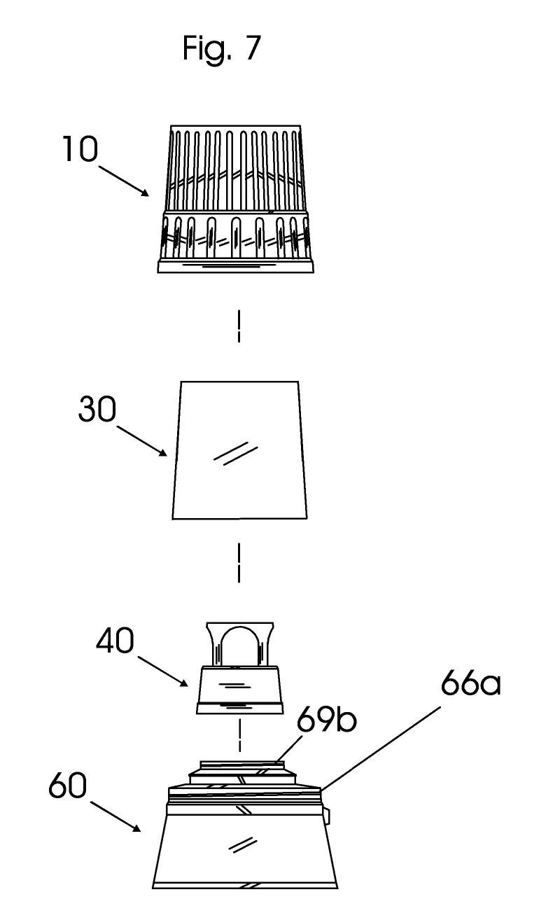

FIG. 6A-6C show side, bottom, and top views of the shade and lampholder 60. The shade and lampholder 60 includes sections 61, 62, 64, 65, 66, 67, 68, 69, and 69a. The sections 61, 62, 65, 66, 67, 69, are substantially cylindrical with a decreasing outer and inner diameter from an end 60c to an end 60a. Sections 64, 68, and 69 are substantially cylindrical. Section 69a may include threads 69b for connecting to inner threads 41, shown in FIG. 1, of the air diffuser 40, for attaching the air diffuser 40 to the section 69a of the shade and lampholder 60, as shown in FIG. 7. Section 66 has ridges or threads 66a for attaching to internal threads 11 of cover 10 for attaching cover 10 to the shade and lampholder 60. The shade and lampholder 60 also includes port 63 for attaching to top connector 80, shown in FIG. 3.

Referring to FIG. 6B, the shade and lampholder 60 also includes a grill or screen 70. The grill or screen 70 includes a plurality of circular members 71, such as circular member 71a. The grill or screen 70 also includes a plurality of vertical or horizontal members 72, such as member 72a, which attach the grill or screen 70 to the section 61 of the shade and lampholder 60, through slots 73a, 73b, 73c, and 73d. The shade and lampholder 60 also includes a housing 74, a fan 75, and a lamp 76, which are shown in a simplistic form in FIG. 6B and 6C. The housing 74, fan 75, and lamp 76 are shown with dashed lines and generally can be largely seen through the spaces in the screen 70 in FIG. 6B and can be seen somewhat through an opening 60b in the shade and lampholder 60 in FIG. 6C.

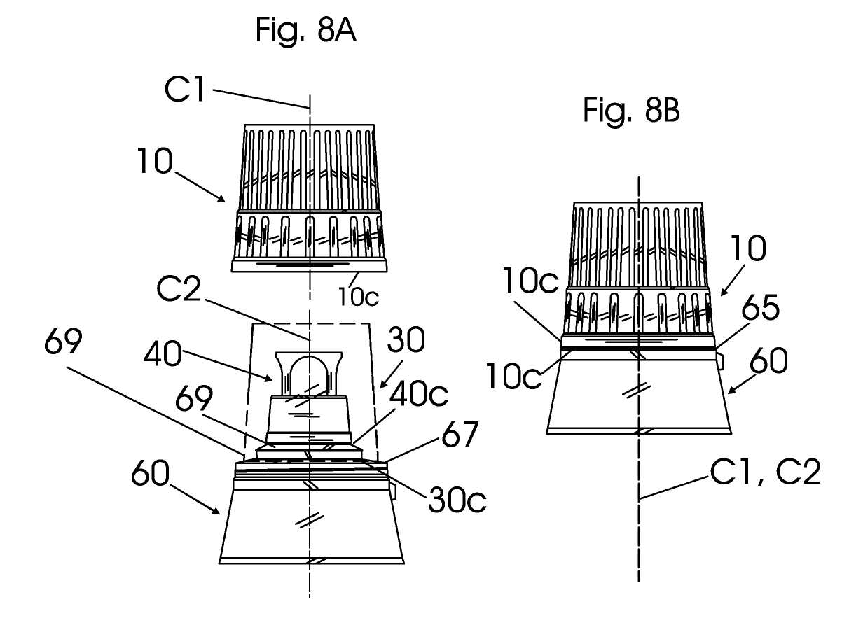

FIG. 7 shows a front view of the cover 10, filter 30, and air diffuser 40 and the shade or hood 60. FIG. 8A shows a front view of the air diffuser 40 connected to the shade 60 and the filter 30 placed over the air diffuser 40, with the filter shown in dashed lines, and the cover 10 unattached from the shade 60. The air diffuser 40 has a central axis of symmetry C2. The shade 60 also has a central axis of symmetry, which is also C2, when the air diffuser 40 is connected to the shade 60 as in FIG. 8A. The air diffuser 40 is connected to the shade 60 by screwing the threads or grooves 41, shown in FIG. 1, onto the threads or grooves 69b, shown in FIG. 7. The filter 30 is typically fabric and is merely laid over the air diffuser 40. The filter 30 may also have a central axis of symmetry which may also be C2 when the filter 30 is placed over the air diffuser 40 as in FIG. 8A.

The cover 10 has a central axis of symmetry C1. FIG. 8B shows a front view of the cover 10 attached to the shade 60. The central axis of symmetry C1 and the central axis of symmetry C2 are aligned and are the same when the cover 10 is attached to the shade 60 as in FIG. 8B. The cover 10 is attached by screwing the threads or grooves 11, shown in FIG. 1, onto the threads or grooves 66a shown in FIG. 7.

In operation, the completed apparatus 1 of FIG. 3 functions as follows. An individual turns on the device by turning on a switch 81. This turns on the fan 75 as well as the light 76. Light is projected in the direction D1, shown in FIG. 3, from the light 76. The fan 75 causes air to be sucked into a chamber 60e of the lamp and shadeholder 60 through the end 60c, and through an opening 60d. The air then flows from the chamber 60e of the lamp and shadeholder 60, through an opening 69c, shown in FIG. 6C, into the chamber 40d, shown in FIG. 1, of the air diffuser 40. The air then flows from the chamber 40d through openings 50, 52, 54, and 56 shown FIGS. 1 and 4A-C, through the filter 30, and then out the elongated openings 22 of the cover 10, shown in FIG. 5A.

This apparatus 1 of FIG. 3, in at least one embodiment sucks dusts and powders in the air that result from brushing nails, ceramics, and other plastic composites, and filters these dusts and powders as well as reducing the chemical smells of these powders. The powders may include human hand and toe nail bones, UV-Jell, jell powder, and acrylic powder in the nail salon industry and plastic composites and ceramics in dental technician offices. Smells come from acryl, acetone, glue and other chemicals. These powders and smells have caused nail salon technician and dental technicians serious diseases and illness. The apparatus 1 can help many nail salon technicians and dental mechanics or technicians to inhale cleaner air. The apparatus 1 may used low noise, semi-permanent lifetime brushless DC motor not shown to power the fan 75, and easy to change activated carbon fiber filters for filter 30. The lamp 76 may use a no heat LED lamp.

The air diffuser 40 may diffuse the sucked air to the four openings 50, 52, 54, and 56 aerodynamically so that the air diffuser 40 prevents powders and dusts from scaling up on top of the cover 10 in turn, falling down back to a customer's hands. The lamp 76 allows dusts which are being sucked into the shade and lampholder 60 to be seen.

The top connector 80 braces the head or combination of the shade and lampholder 60, diffuser 40, filter 30, and cover 10. The top connector 80 also has an electric terminal or wire 80a which connects to the power supply and/or fan/motor inside the shade and lampholder 60.

The flexible or goose neck stand 82 helps a service man to place the shade and lampholder 60 toward a customer's hands, and also keeps electric wires inside the stand or flexible member 82 for safety. The bottom connector 84 may have an electric inlet terminal and/or electrical wire 80a for connecting to a plug 84b, or may have a twelve volt DC to A/C adapter.

The apparatus 1 may have a power supply and may receive an input such as
100 to 240V˜30 VA 50/60 Hz alternating current from a standard household electrical outlet, and may supply the fan 75 with an output of twelve volts direct current and 1.5 amps.

The sum of the area of the four openings 50, 52, 54, and 56 of the air diffuser 40 shown in FIGS. 4A-C, should exceed the area of opening 69c at the top of shade 60 shown in FIG. 6C.

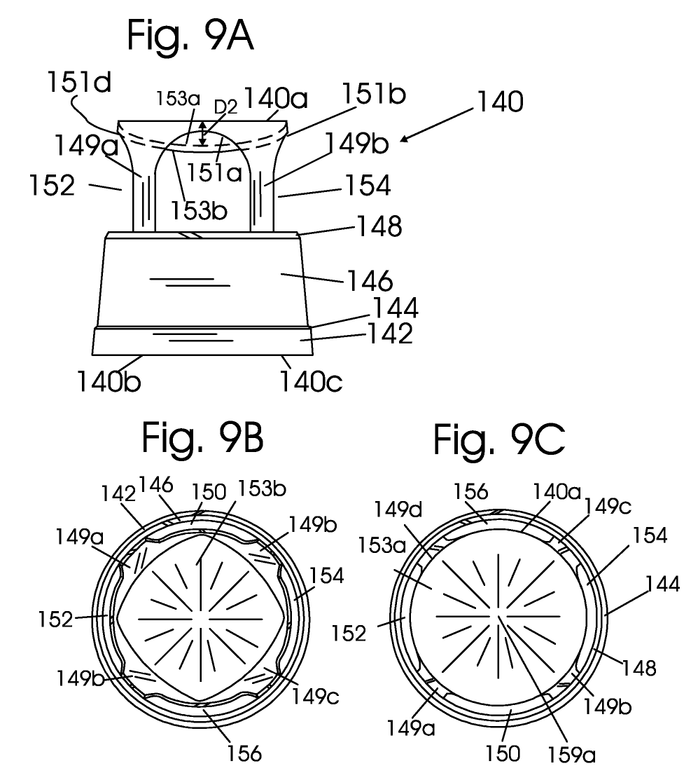

FIG. 9A shows a side view of an air diffuser 140 in accordance with another embodiment of the present invention. The air diffuser 140 can be used with the cover 10, filter 30 and shade or lamp holder 60, as an alternative to air diffuser 40. FIG. 9B shows a bottom view of the air diffuser 140. FIG. 9C shows a top view of the air diffuser 140.

The air diffuser 140 is similar to the air diffuser 40 with exceptions as will be described. The air diffuser 140 has a top surface 153a which is curved inwards, or concave, like the inside of a bowl as shown by FIG. 9A and FIG. 9C. In FIG. 9C, the surface 153a curves into the page. The air diffuser 140 has an inner surface 153b, which is parallel to the outer or top surface 153a and which in FIG. 9B, curves out of the page. This differs from the air diffuser 40, which has a flat top surface 53a and flat inner surface 53b. A portion of the inner surface 153b, which can be seen in the view of FIG. 9A is shown by a solid line, while a portion of the inner surface 153b which would be hidden in the view of FIG. 9A is shown by a dashed line. Similarly the location of outer or top surface 153a, which would be hidden in the view of FIG. 9A, is shown by a dashed line.

The air diffuser 140 includes sections 142, 144, 146, 148, 149a, 149b, 149c, and 149d. Each of sections 142, 144, 146, and 148 are substantially cylindrical with a decreasing outer and inner diameter from an end 140c towards end 140a. This may allow plastic to be molded more easily. The air diffuser 140 also includes openings 150, 152, 154, and 156. The openings 150, 152, 154, and 156 may be the same size spaced uniformly around the perimeter of the air diffuser 140. The openings 150, 152, 154, and 156 have a substantially rectangular portion near section 148 and a semicircular portion near end 140a. Each of the openings 150, 152, 154, and 156 may have a width of W7, which may be about one and seven eighths inches, and a height Hl, which may be about one and seven eighths inches.

The top surface 153a may curve or project inward a distance of D2, shown in FIG. 9A, which may be the distance between the vertical position of the end 140a on the perimeter of the top surface 153a and the center 159a, shown in FIG. 9C, of the top surface 153a. The distance D2 may be about twenty millimeters. The use of a dome like surface for top surface 153a may provide better ventilation. It is also possible that an alternative air diffuser can be provided with a convex top surface, projecting outward away from an end, similar to 140b. For some purposes a convex top surface, not shown in FIG. 4A or 9A, may be most efficient.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

What is claimed is:

1. An apparatus comprising:
an air diffuser;
a filter;
a cover;
a fan; and
a shade in which the fan is located;
wherein the air diffuser is surrounded by the filter except for a bottom opening in the air diffuser at a bottom of the air diffuser;
wherein the cover surrounds the filter and the air diffuser except for an opening in the filter at a bottom of the filter and the bottom opening in the air diffuser;
wherein the air diffuser is attached to the shade;
wherein the cover is attached to the shade; and
wherein the shade has an opening; and
and wherein the fan causes air to flow into the shade through the opening of the shade, then through the bottom opening of the air diffuser, the filter, and a first opening of the cover, then out a set of a plurality of openings in a side of the air diffuser, then through the filter, and then out a set of a plurality of openings in the cover.

2. The apparatus of claim 1 wherein
the set of the plurality of openings in the cover are substantially uniformly spaced.

3. The apparatus of claim 1 wherein
the air diffuser is substantially frustroconical in shape and has a central axis;
the cover is substantially frustroconical in shape and has a central axis; and
the air diffuser and the cover are attached to the shade so that the central axis of the air diffuser and the central axis of the cover substantially overlap.

4. The apparatus of claim 1 wherein
the air diffuser is substantially symmetrical about its central axis.

5. The apparatus of claim 1 wherein
the set of the plurality of openings in the side of the air diffuser are uniformly spaced.

6. The apparatus of claim 1 wherein
the cover is substantially symmetrical about its central axis.

7. The apparatus of claim 1 wherein
the shade has a light located therein.

8. A method comprising
vacuuming noxious particles and fumes by using an apparatus including
an air diffuser;
a filter;
a cover;
a fan; and
a shade in which the fan is located;
wherein the air diffuser is surrounded by the filter except for a bottom opening in the air diffuser at a bottom of the air diffuser;
wherein the cover surrounds the filter and the air diffuser except for an opening in the filter at a bottom of the filter and the bottom opening in the air diffuser;
wherein the air diffuser is attached to the shade;
wherein the cover is attached to the shade; and
wherein the shade has an opening; and
wherein the fan causes air to flow into the shade through the opening of the shade, then through the bottom opening of the air diffuser, the filter, and a first opening of the cover, then out a set of a plurality of openings in a side of the air diffuser, then through the filter, and then out a set of a plurality of openings in the cover.

9. The method of claim 8 wherein
the set of the plurality of openings in the cover are substantially uniformly spaced.

10. The method of claim 8 wherein
the air diffuser is substantially frustroconical in shape and has a central axis;
the cover is substantially frustroconical in shape and has a central axis; and
the air diffuser and the cover are attached to the shade so that the central axis of the air diffuser and the central axis of the cover substantially overlap.

11. The method of claim 8 wherein
the air diffuser is substantially symmetrical about its central axis.

12. The method of claim 8 wherein
the set of the plurality of openings in the side of the air diffuser are uniformly spaced.

13. The method of claim 8 wherein
the cover is substantially symmetrical about its central axis.

14. The method of claim 8 wherein
the shade has a light located therein.

15. The method of claim 8 wherein
the noxious particles and fumes are created by a finger nail treatment process.
